(19) United States
(12) Patent Application Publication
(10) Pub. No.: US 2024/0294394 A1
(43) Pub. Date: Sep. 5, 2024

(54) COMPOSITE TRANSITION METAL PRECURSOR FOR CATHODE ACTIVE MATERIAL, AND SECONDARY BATTERY CATHODE ACTIVE MATERIAL PREPARED THEREFROM

(71) Applicant: L&F CO., LTD., Daegu (KR)

(72) Inventors: Sun Hong PARK, Daegu (KR); Won Gyeong KANG, Daegu (KR); Sung Kyun CHANG, Daegu (KR); Doe Hyoung KIM, Daegu (KR)

(21) Appl. No.: 18/031,191

(22) PCT Filed: Sep. 29, 2021
(86) PCT No.: PCT/KR2021/013300

§ 371 Date: Sep. 1, 2023

(30) Foreign Application Priority Data
Oct. 14, 2020 (KR) 10-2020-0132354

(51) Int. Cl. C01G 53/00; H01M 10/052

(52) U.S. Cl. CPC C01G 53/006; H01M 10/052; C01P 2002/74

(57) ABSTRACT

Disclosed is a composite transition metal precursor for a cathode active material containing Ni and at least one transition metal, wherein a molar amount of Ni is 60% or more based on a total amount of transition metal and a ratio (I₁₀₁/I₀₀₁) of an intensity of a (101) plane to an intensity of a (001) plane ranges from 0.7 to 1.1 in XRD analysis.

### TECHNICAL FIELD

The present invention relates to a composite transition metal precursor for a cathode active material and a cathode active material for a secondary battery prepared therefrom, and more particularly, to a composite transition metal precursor which contains a high amount of Ni and satisfies a certain ratio (I₁₀₁/I₀₀₁) of the intensity of the (101) plane to the intensity of the (001) plane, as determined by XRD analysis, to provide excellent structural stability and superior reactivity with a lithium source, and a cathode active material for a secondary battery prepared using the same.

### BACKGROUND ART

Secondary batteries have been mainly used in portable electronic devices owing to excellent power output and high energy density thereof. Recently, as concerns about environmental issues have emerged, application of secondary batteries has expanded to medium and large-sized fields such as transportation fields such as electric vehicles (HEVs, PHEVs, and EVs) and power storage devices such as energy storage systems (ESSs). The expansion to various fields requires high efficiency, high capacity and stability, which remain unsolved.

Representative cathode active materials for secondary batteries include LiNiO₂, LiCoO₂, LiMn₂O₄, and the like. LiCoO₂ has a high operating voltage and excellent capacity characteristics, but has drawbacks of very poor thermal characteristics due to the destabilized crystal structure caused by delithiation and high cost. On the other hand, LiMn₂O₄ is cost-efficient and has excellent power output and stability, but has a problem in that structural deformation caused by Mn³⁺ during charging and discharging results in Mn elution at high temperatures and rapid change in functions. In addition, LiNiO₂ has a high capacitance, but has problems associated with cycle characteristics and safety during charging and discharging.

In order to address these problems, research is actively conducted on ternary composite oxides having a layered structure based on elements such as Ni, Co, and Mn. Recently, research on high-Ni (70% or more of Ni) cathode active materials, which are superior in price competitiveness to Co and have excellent discharge capacity and output performance, and competition for market share in cathode materials is fierce.

Conventional low-Ni (less than 60% Ni) cathode active materials react well at low temperatures because they have no problem with reactivity with Li, whereas high-Ni cathode active materials have problems of difficulty in a firing process such as long firing time, use of LiOH, and oxygen injection due to low reactivity with Li. This may be due to structural instability.

Therefore, there is demand for methods for improving reactivity, which is the problem of the conventional firing process and for maximizing structural stability and productivity by preparing a highly reactive precursor even in high-Ni cathode active materials based on improvement of the structural stability of a precursor for cathode active materials.

### DISCLOSURE

### Technical Problem

Therefore, the present invention has been made to solve the above and other technical problems that have yet to be solved.

After repeated extensive research and various experiments, the present inventors have identified the requirements for defining a structurally stable material for a precursor for preparing high-Ni cathode active materials through XRD analysis and presented a precursor for preparing cathode active materials that can realize excellent initial capacity and electrochemical performance in high-Ni cathode active materials.

### Technical Solution

In accordance with an aspect of the present invention, provided is a composite transition metal precursor for a cathode active material containing Ni and at least one transition metal, wherein a molar amount of Ni is 60% or more based on the total amount of transition metal and a ratio (I₁₀₁/I₀₀₁) of an intensity of the (101) plane to an intensity of the (001) plane ranges from 0.7 to 1.1 in an XRD analysis.

According to the present invention, a composite transition metal precursor containing 60 mol % or more of Ni may be referred to as a “high-Ni precursor”. A preferable Ni content in such a high-Ni precursor may be 70 mol % or more, and in a specific example, may be in the range of 70 mol % to 98 mol %.

In general, high-Ni-based precursors are prepared by co-precipitation to ensure uniformity of particles and easy preparation, and raw materials used to obtain the precursors are metal salts such as MeSO₄ (Me: a transition metal element including Ni), NaOH and NH₄OH. Thereamong, NaOH is used as a raw material to adjust the pH for precipitation, and NH₄OH is used as a chelating agent to facilitate formation of complexes.

In general, high-Ni-based precursors are prepared by a co-precipitation method to ensure uniformity of particles and ease of manufacture, and raw materials used to obtain the precursors are metal salts such as MeSO₄ (Me: a transition metal element including Ni), NaOH and NH₄OH are used as raw materials. Thereamong, NaOH is used as a raw material for pH adjustment for precipitation, and NH₄OH is used as a chelating agent to help form complexes.

A general co-precipitation reaction mechanism is performed in accordance with the following reaction (a) or (b) depending on the presence or absence of a chelating agent.

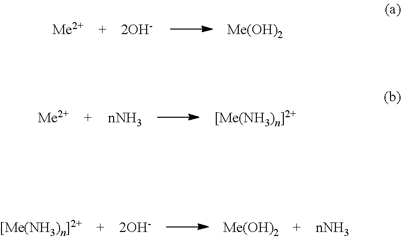

The first material produced during the precipitation has an octahedral structure having six coordination bonds to a transition metal (Me). Me²⁺ (Ni²⁺, Co²⁺, Mn²⁺) is disposed in the center and 6 OH⁻ groups are disposed at the top and bottom, forming the (001) plane of the crystal structure in FIG. 1. Then, ammonia is converted into a complex ion of [Me(NH₃)ₙ]²⁺ together with metal. It has such a complex cation and a large amount of OH⁻ groups and thus releases Me²⁺ due to electrostatic force when it is close to the negatively charged (001) surface. The released Me²⁺ precipitates on the (001) plane, which grows the (010) plane, not the (001) plane, along the c-axis.

In general, since the crystal growth rate of the high-energy plane is higher than the crystal growth rate of the low-energy plane during growth of the precursor particles, the high-energy plane disappears during growth, and the grown crystal plane is dominated by the low-energy plane. Here, the high surface energy of the crystal plane is determined by the atomic structure arrangement, and as the number of unbonded bonds on the atom increases, the surface energy increases. The precursor for the cathode active material thus formed is arranged in a structure similar to a monoclinic system.

Representative major peaks that can be identified in the monoclinic system are (001), (100 or 010), and (101), and the position of the peak of the (010) plane is the same as that of the (100) plane. In addition, in a perfect crystal, the (100) plane and the (010) plane are identical, and the (010) plane is a plane related to the behavior of Li. Excessive formation of the particles at [010] is the same as in formation of the wide plane (001). The (001) plane itself has no electrochemical activity. When the (001) plane widens, it is difficult for Li to diffuse into the inside of the plane (001), resulting in formation of an unstable layered structure. In order to solve this phenomenon, the particles need to grow at [001] of the c-axis direction to maximize the exposure of the (010) plane and thereby providing efficient storage and intercalation/deintercalation of Li.

The structure of the formed particles of precursor depends on the co-precipitation conditions, which can be confirmed through XRD pattern analysis. When XRD analysis of the precursor is performed, a peak close to β-Ni(OH)₂ can be obtained. The peak observed at around 18° corresponds to the intensity of the (001) plane, the peak observed at around 33° corresponds to the intensity of the (100) plane, and the peak observed at around 38° corresponds to the intensity of the (101) plane, which can also be confirmed from the XDR analysis results of FIG. 3.

The present inventors determined whether or not the performance of the active material is changed by the ratio between the planes of the precursor through in-depth analysis and presents the optimal ratio based thereon.

Specifically, design to secure structural stability is essential because the structure of the precursor is directly related to the electrochemical properties of the cathode active material. The crystal structure of the precursor is similar to a monoclinic system which is different from that of the cathode active material. For example, when the precursor NCM(OH)₂ and Li source are mixed and fired, the crystal structure of the precursor is rearranged and changed to a a-NaFeO₂/hexagonal layered structure. At this time, the crystal structure of the precursor affects the active material of the crystal structure.

When the cathode active material is observed from the axis of HCP (hexagonal close packed) with reference to FIG. 2, the a-axis represents an average distance between metal ions, and as the a-axis decreases, the metal ion lattice constant decreases. In this case, the bonding force between atoms increases and thus structural stability can be secured. However, an excessively narrow a-axis may disadvantageously cause more grain boundaries in the active material, thus blocking movement of Li.

The c-axis refers to the distance between metal layers. As the number of planes of the c-axis or the distance between planes of the c-axis increases, the intercalation and deintercalation of Li ions become smooth and structural stress is advantageously reduced. However, when the interlayer distance is excessively great, the electrostatic force between Li and oxygen is removed, a Li vacancy is formed, and Ni with a similar ionic radius is located in the vacancy, eventually resulting in formation of a Ni—O (rock-salt) structure.

Therefore, the crystal structure of the precursor is an important factor in forming the crystal structure of the cathode active material. That is, when a precursor is obtained through a co-precipitation reaction, the growth conditions to form the precursor determine the crystal structure of the precursor and the behaviors of Li during firing, thus eventually affecting the electrochemical properties.

The foregoing supports that, when the ratio of the (101) plane to the (001) plane, that is, the ratio of (I₁₀₁/I₀₀₁) of the intensity of the (101) plane to the intensity of the (001) plane satisfies the range defined above, from 0.7 to 1.1, in the crystal structure of based on XRD analysis, a precursor capable of preparing a cathode active material with excellent electrochemical properties can be obtained, as can be seen from the subsequent experiments.

The ratio of the (101) plane to the (001) plane means the lattice distance between metal atoms. When the lattice distance is excessively great or small, crystallinity is lowered, resistance to intercalation/deintercalation of Li occurs, and structural collapse and cation mixing may be serious. When the intensity ratio falls within the range of 0.7 to 1.1, the crystallinity and the bonding between metal atoms and Li ions are excellent.

In a preferred example, in addition to the ratio of the (101) plane to the (001) plane, the ratio of the (100) plane to the (001) plane, that is, the peak intensity ratio (I₁₀₁/I₀₀₁) of the (100) plane to the (001) plane, satisfies the range from 0.4 to 0.8.

In the XRD peak, the planes (100) and (001) are scales indicating Li intercalation/deintercalation layers arranged along the c-axis. When the intensity ratio falls within the range of 0.4 to 0.8, diffusion of Li can proceed smoothly due to increased exposure of Li intercalation/deintercalation layer to the (010) plane.

In a preferred embodiment, the intensity ratio (I₁₀₁/I₀₀₁) of the (101) plane and the (001) plane may range from 0.74 to 1.08, and the peak intensity ratio (I₁₀₁/I₀₀₁) of the (100) plane and the (001) plane may range from 0.43 to 0.76.

As described above, the composite transition metal precursor of the present invention further includes at least one transition metal in addition to Ni, and may include Co and Mn in a specific example.

A high-Ni precursor containing 60 mol % or more of Ni and further containing Co and Mn can be prepared by co-precipitation and may be, for example, at least one selected from the group consisting of M(OH)₂, M(OOH) and M(OH₁₋ₓ)₂ (wherein M includes Ni and at least one transition metal, and x satisfies the requirement of 0<x<0.5).

In a specific example, the composite transition metal precursor may be a material represented by Formula 1 below:

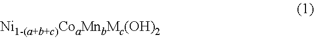

wherein
M includes at least one element selected from the group consisting of B, Al, Ti, Sc, V, Cr, Fe, Y, Cu, Zr, Nb, Mo, Tc, Ru, Rh, Ag, Pd, P, W, and the like; and
the requirements of 0≤a<1, 0≤b<1, 0≤c<1 and 0<a+b+c≤0.3 are satisfied.

The precursor of the present invention may be composed of single particles, secondary particles in which primary particles are aggregated, or a mixture of primary and secondary particles, and the size of the primary particles may, for example, range from 0.01 m to 0.5 m, and the size of the secondary particles may range from 1.5 m to 50 m, but is not particularly limited thereto.

The crystal structure of such a composite transition metal precursor may slightly vary depending on various process factors associated with each other, such as pH, ammonia concentration, reaction time, stirring speed of reactants, and content ratios of transition metals in the co-precipitation process for preparation thereof. Examples of preparing precursors satisfying the crystal structure conditions defined in the present invention, such as various transition metal component ratios, particle sizes, and the like are described in the experiments later. However, it is obvious that those skilled in the art could prepare a precursor that satisfies the conditions of the crystal structure defined in the present invention through appropriate adjustment of process conditions without being limited to the description of these related experiments.

For example, with respect to the relationship between pH and ammonia, as can be seen from the experimental details described later, when the pH is set to 12.0 or higher in the co-precipitation process, the amount of caustic soda as a precipitant in the reaction increases, and an octahedral structure is created in Me forming the plane (001), which affects the intensity ratio, as described above. The amount of ammonia is adjusted depending on the set pH. As the amount of ammonia decreases, formation of the plane (100 or 010) or plane (101) is difficult, and as the amount increases, the rear surface of the crystals grows.

The present invention also provides a cathode active material prepared by firing the composite transition metal precursor along with a lithium source.

The cathode active material according to the present invention may have an intensity ratio I (003/104) of the plane (003) to the (104) plane of 1.8 or more, preferably of 1.8 to 2.1 in the XRD main peak.

The intensity ratio of I (003/104) is a value indicating the degree of cation mixing, and the cation mixing refers to a phenomenon in which Ni²⁺ (0.69 Å) and Li²⁺ (0.76 Å) interchange in position with each other because Ni²⁺ (0.69 Å) has a similar size to Li²⁺ (0.76 Å). Therefore, when the intensity ratio is closer to 1.2, the mixing amount of the two ions increases and the properties thereof deteriorate, and when the intensity ratio is higher than 1.2, the mixing amount of the two ions decreases, and electrochemical properties are excellent. It can be seen from experiments described later that the cathode active material of the present invention exhibits an intensity ratio of 1.8 or more, which is a much higher value than 1.2.

In a specific embodiment, the cathode active material according to the present invention may satisfy the condition of c/a=4.9 or more in XRD analysis, and a layered structure is formed well under the condition that the value of c/a is 4.9 or more.

The cathode active material according to the present invention has high particle strength, excellent lifespan, low initial resistance, and high capacity, which is also proven from experiments described later.

The present invention also provides a lithium secondary battery including the cathode active material, and the structure of the lithium secondary battery and the method of preparing the same are known in the art and thus a detailed description thereof is omitted herein.

### Effects of the Invention

As described above, the composite transition metal precursor according to the present invention has excellent reactivity and structural stability when fired with a lithium source, thereby reducing the cost of the firing process and providing an electrochemically excellent cathode active material.

### BRIEF DESCRIPTION OF DRAWINGS

FIG. 1 is graphs showing crystal planes in a solid crystal structure;

FIG. 2 is a diagram showing a hexagonal close packed (HCP) system in a solid crystal structure;

FIG. 3 is XRD graphs in Experimental Example 1; and

FIG. 4 is SEM images illustrating cathode active materials of Example 1 and Comparative Example 1.

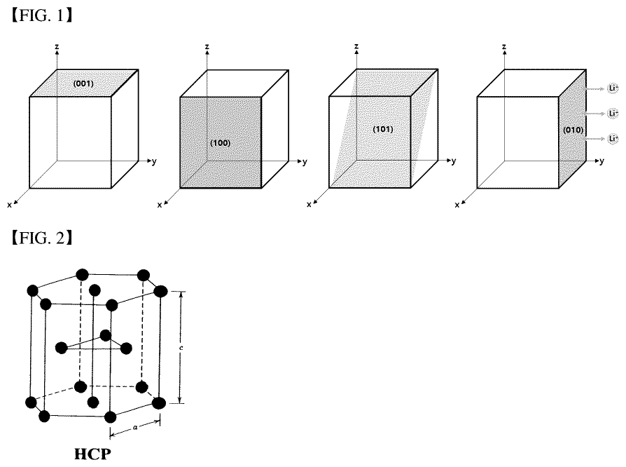

### BEST MODE

Now, the present invention will be described in more detail with reference to the following examples. These examples should not be construed as limiting the scope of the present invention.

### Example 1

200 L of water, caustic soda, and ammonia were added to a 500 L cylindrical reactor into which nitrogen gas was injected at a constant rate of 0.1 L/min, stirred at a constant rate of 360 rpm and allowed to maintain a pH of 12.3 to 12.6 and an ammonia concentration of 7,000 to 8,000 ppm. Then, an aqueous metal salt solution having a Ni:Co:Mn molar ratio of 80:10:10 along with caustic soda and an aqueous ammonia solution were continuously added to the reactor using a metering pump and synthesis was performed at 60° C. by coprecipitation.

D50 at a reaction time of 20 hours was 10 m. In this case, the pH was adjusted to 11.3 to 11.7 and the amount of ammonia was adjusted to 4,000 to 5,000 ppm to obtain Ni—Co—Mn composite transition metal hydroxide particles.

The hydroxide particles obtained through this process were washed, filtered, and dried at 130° C. for 16 hours to remove moisture. As a result, a composite transition metal hydroxide powder was prepared.

LiOH was mixed with the composite transition metal hydroxide precursor prepared above at a molar ratio of 1.03, followed by heat-treating at 800° C. for 18 hours to prepare a cathode active material.

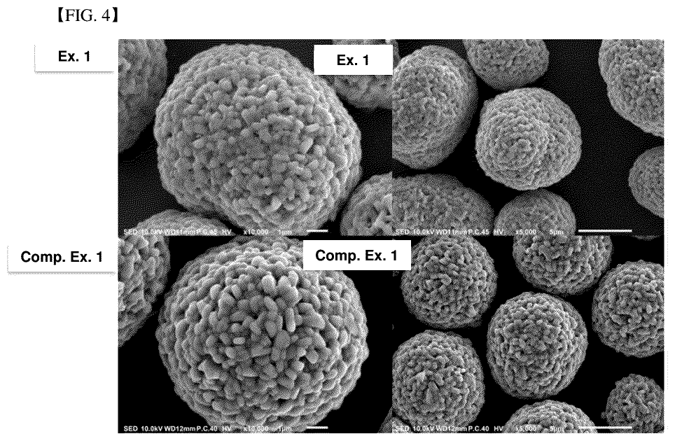

FIG. 4 is an SEM image of the cathode active material. It can be seen that primary particles of the cathode active material of Example 1 are denser than those of the cathode active material of Comparative Example 1. This is because, when the XRD peak condition defined in the present invention is satisfied, the movement of Li in the precursor is smooth during firing, so Li is well inserted into the secondary particles of the precursor, is uniformly present on the surface thereof and becomes denser.

### Example 2

200 L of water, caustic soda, and ammonia were added to a 500 L cylindrical reactor into which nitrogen gas was injected at a constant rate of 0.1 L/min, stirred at a constant rate of 360 rpm and allowed to maintain a pH of 12.0 to 12.4 and an ammonia concentration of 4,000 to 5,000 ppm. Then, an aqueous metal salt solution having a Ni:Co:Mn molar ratio of 80:10:10 along with caustic soda and an ammonia aqueous solution were continuously added to the reactor using a metering pump and synthesis was performed at 60° C. by coprecipitation.

D50 at a reaction time of 20 hours was 10 m. In this case, the pH was adjusted to 11.3 to 11.7 and the amount of ammonia was adjusted to 4,000 to 5,000 ppm to obtain Ni—Co—Mn composite transition metal hydroxide particles.

The hydroxide particles obtained through this process were washed, filtered, and dried at 130° C. for 16 hours to remove moisture. As a result, a composite transition metal hydroxide powder was prepared.

LiOH was mixed with the composite transition metal hydroxide precursor prepared above at a molar ratio of 1.03, followed by heat-treating at 800° C. for 18 hours to prepare a cathode active material.

### Example 3

200 L of water, caustic soda, and ammonia were added to a 500 L cylindrical reactor into which nitrogen gas was injected at a constant rate of 0.1 L/min, stirred at a constant rate of 360 rpm and allowed to maintain a pH of 12.5 to 12.9 and an ammonia concentration of 7,000 to 8,000 ppm. Then, an aqueous metal salt solution having a Ni:Co:Mn molar ratio of 80:10:10 along with caustic soda and an aqueous ammonia solution were continuously added to the reactor using a metering pump and synthesis was performed at 60° C. by coprecipitation.

D50 at a reaction time of 20 hours was 10 m. In this case, the pH was adjusted to 11.3 to 11.7 and the amount of ammonia was adjusted to 4,000 to 5,000 ppm to obtain Ni—Co—Mn composite transition metal hydroxide particles.

The hydroxide particles obtained through this process were washed, filtered, and dried at 130° C. for 16 hours to remove moisture. As a result, a composite transition metal hydroxide powder was prepared.

LiOH was mixed with the composite transition metal hydroxide precursor prepared above at a molar ratio of 1.03, followed by heat-treating at 800° C. for 18 hours to prepare a cathode active material.

### Example 4

200 L of water, caustic soda, and ammonia were added to a 500 L cylindrical reactor into which nitrogen gas was injected at a constant rate of 0.1 L/min, stirred at a constant rate of 360 rpm and allowed to maintain a pH of 11.5 to 11.6 and an ammonia concentration of 4,000 to 5,000 ppm. Then, an aqueous metal salt solution having a Ni:Co:Mn molar ratio of 82:11:07 along with caustic soda and an aqueous ammonia solution were continuously added to the reactor using a metering pump and synthesis was performed at 60° C. by coprecipitation.

D50 at a reaction time of 20 hours was 10 m. In this case, the pH was adjusted 11.3 to 11.7 and the amount of ammonia was adjusted to 4,000 to 5,000 ppm to obtain Ni—Co—Mn composite transition metal hydroxide particles.

The hydroxide particles obtained through this process were washed, filtered, and dried at 130° C. for 16 hours to remove moisture. As a result, a composite transition metal hydroxide powder was prepared.

LiOH was mixed with the composite transition metal hydroxide precursor prepared above at a molar ratio of 1.03, followed by heat-treating at 800° C. for 18 hours to prepare a cathode active material.

### Example 5

200 L of water, caustic soda, and ammonia were added to a 500 L cylindrical reactor into which nitrogen gas was injected at a constant rate of 0.1 L/min, stirred at a constant rate of 360 rpm and allowed to maintain a pH of 12.3 to 12.6 and an ammonia concentration of 7,000 to 8,000 ppm. Then, an aqueous metal salt solution having a Ni:Co:Mn molar ratio of 80:10:10 along with caustic soda and an aqueous ammonia solution were continuously added to the reactor using a metering pump and synthesis was performed at 60° C. by coprecipitation.

D50 at a reaction time of 20 hours was 3 m. In this case, the pH was adjusted to 11.5 to 11.8 and the amount of ammonia was adjusted to 4,000 to 5,000 ppm to obtain Ni—Co—Mn composite transition metal hydroxide particles.

The hydroxide particles obtained through this process were washed, filtered, and dried at 130° C. for 16 hours to remove moisture. As a result, a composite transition metal hydroxide powder was prepared.

LiOH was mixed with the composite transition metal hydroxide precursor prepared above at a molar ratio of 1.03, followed by heat-treating at 800° C. for 18 hours to prepare a cathode active material.

### Example 6

200 L of water, caustic soda, and ammonia were added to a 500 L cylindrical reactor into which nitrogen gas was injected at a constant rate of 0.1 L/min, stirred at a constant rate of 360 rpm and allowed to maintain a pH of 12.0 to 12.1 and an ammonia concentration of 7,000 to 8,000 ppm. Then, an aqueous metal salt solution having a Ni:Co:Mn molar ratio of 80:10:10 along with caustic soda and an aqueous ammonia solution were continuously added to the reactor using a metering pump and synthesis was performed at 60° C. by coprecipitation.

D50 at a reaction time of 20 hours was 16 m. In this case, the pH was adjusted to 11.6 to 12.0 and the amount of ammonia was adjusted to 7,000 to 10,000 ppm to obtain Ni—Co—Mn composite transition metal hydroxide particles.

The hydroxide particles obtained through this process were washed, filtered, and dried at 130° C. for 16 hours to remove moisture. As a result, a composite transition metal hydroxide powder was prepared.

LiOH was mixed with the composite transition metal hydroxide precursor prepared above at a molar ratio of 1.03, followed by heat-treating at 800° C. for 18 hours to prepare a cathode active material.

### Example 7

200 L of water, caustic soda, and ammonia were added to a 500 L cylindrical reactor into which nitrogen gas was injected at a constant rate of 0.1 L/min, stirred at a constant rate of 360 rpm and allowed to maintain a pH of 12.3 to 12.6 and an ammonia concentration of 7,000 to 8,000 ppm. Then, an aqueous metal salt solution having a Ni:Co:Mn molar ratio of 70:15:15 along with caustic soda and an aqueous ammonia solution were continuously added to the reactor using a metering pump and synthesis was performed at 60° C. by coprecipitation.

D50 at a reaction time of 20 hours was 10 m. In this case, the pH was adjusted to 11.3 to 11.7 and the amount of ammonia was adjusted to 4,000 to 5,000 ppm to obtain Ni—Co—Mn composite transition metal hydroxide particles.

The hydroxide particles obtained through this process were washed, filtered, and dried at 130° C. for 16 hours to remove moisture. As a result, a composite transition metal hydroxide powder was prepared.

LiOH was mixed with the composite transition metal hydroxide precursor prepared above at a molar ratio of 1.03, followed by heat-treating at 800° C. for 18 hours to prepare a cathode active material.

### Example 8

200 L of water, caustic soda, and ammonia were added to a 500 L cylindrical reactor into which nitrogen gas was injected at a constant rate of 0.1 L/min, stirred at a constant rate of 360 rpm and allowed to maintain a pH of 12.3 to 12.6 and an ammonia concentration of 7,000 to 8,000 ppm. Then, an aqueous metal salt solution having a Ni:Co:Mn molar ratio of 90:05:05 along with caustic soda and an aqueous ammonia solution were continuously added to the reactor using a metering pump and synthesis was performed at 60° C. by coprecipitation.

D50 at a reaction time of 20 hours was 10 m. In this case, the pH was adjusted to 11.3 to 11.7 and the amount of ammonia was adjusted to 4,000 to 5,000 ppm to obtain Ni—Co—Mn composite transition metal hydroxide particles.

The hydroxide particles obtained through this process were washed, filtered, and dried at 130° C. for 16 hours to remove moisture. As a result, a composite transition metal hydroxide powder was prepared.

LiOH was mixed with the composite transition metal hydroxide precursor prepared above at a molar ratio of 1.03, followed by heat-treating at 800° C. for 18 hours to prepare a cathode active material.

### Example 9

200 L of water, caustic soda, and ammonia were added to a 500 L cylindrical reactor into which nitrogen gas was injected at a constant rate of 0.1 L/min, stirred at a constant rate of 360 rpm and allowed to maintain a pH of 12.3 to 12.6 and an ammonia concentration of 7,000 to 8,000 ppm. Then, an aqueous metal salt solution having a Ni:Co:Mn molar ratio of 95:2.5:2.5 along with caustic soda and an aqueous ammonia solution were continuously added to the reactor using a metering pump and synthesis was performed at 60° C. by coprecipitation.

D50 at a reaction time of 20 hours was 10 km. In this case, the pH was adjusted to 11.3 to 11.7 and the amount of ammonia was adjusted to 4,000 to 5,000 ppm to obtain Ni—Co—Mn composite transition metal hydroxide particles.

The hydroxide particles obtained through this process were washed, filtered, and dried at 130° C. for 16 hours to remove moisture. As a result, a composite transition metal hydroxide powder was prepared.

LiOH was mixed with the composite transition metal hydroxide precursor prepared above at a molar ratio of 1.03, followed by heat-treating at 800° C. for 18 hours to prepare a cathode active material.

### Comparative Example 1

An aqueous metal salt solution having a Ni:Co:Mn molar ratio of 82:11:07 along with caustic soda and an aqueous ammonia solution was added to a 500 L cylindrical reactor, into which nitrogen gas was injected at a constant rate of 0.1 L/min, using a metering pump and synthesis was performed at 60° C. by coprecipitation. At this time, the pH was maintained at 11.3 to 11.7, the ammonia concentration was maintained at 4,000 to 5,000 ppm and stirring was performed at a constant rate of 360 rpm to obtain Ni—Co—Mn composite transition metal hydroxide particles having D50 of 10 μm.

LiOH was mixed with the composite transition metal hydroxide precursor prepared above at a molar ratio of 1.03, followed by heat-treating at 800° C. for 18 hours to prepare a cathode active material.

### Comparative Example 2

An aqueous metal salt solution having a Ni:Co:Mn molar ratio of 82:11:07 along with caustic soda and an aqueous ammonia solution was added to a 500 L cylindrical reactor, into which nitrogen gas was injected at a constant rate of 0.1 L/min, using a metering pump and synthesis was performed at 60° C. by coprecipitation. At this time, the pH was maintained at 11.5 to 11.8, the ammonia concentration was maintained at 4,000 to 5,000 ppm and stirring was performed at a constant rate of 360 rpm to obtain Ni—Co—Mn composite transition metal hydroxide particles having D50 of 3 μm.

LiOH was mixed with the composite transition metal hydroxide precursor prepared above at a molar ratio of 1.03, followed by heat-treating at 800° C. for 18 hours to prepare a cathode active material.

### Comparative Example 3

An aqueous metal salt solution having a Ni:Co:Mn molar ratio of 82:11:07 along with caustic soda and an aqueous ammonia solution was added to a 500 L cylindrical reactor, into which nitrogen gas was injected at a constant rate of 0.1 L/min, using a metering pump and synthesis was performed at 60° C. by coprecipitation. At this time, the pH was maintained at 11.6 to 12.0, the ammonia concentration was maintained at 7,000 to 8,000 ppm and stirring was performed at a constant rate of 360 rpm to obtain Ni—Co—Mn composite transition metal hydroxide particles having D50 of 16 μm.

LiOH was mixed with the composite transition metal hydroxide precursor prepared above at a molar ratio of 1.03, followed by heat-treating at 800° C. for 18 hours to prepare a cathode active material.

### Comparative Example 4

An aqueous metal salt solution having a Ni:Co:Mn molar ratio of 70:15:15 along with caustic soda and an aqueous ammonia solution was added to a 500 L cylindrical reactor, into which nitrogen gas was injected at a constant rate of 0.1 L/min, using a metering pump and synthesis was performed at 60° C. by coprecipitation. At this time, the pH was maintained at 11.3 to 11.7, the ammonia concentration was maintained at 4,000 to 5,000 ppm and stirring was performed at a constant rate of 360 rpm to obtain Ni—Co—Mn composite transition metal hydroxide particles having D50 of 10 μm.

LiOH was mixed with the composite transition metal hydroxide precursor prepared above at a molar ratio of 1.03, followed by heat-treating at 800° C. for 18 hours to prepare a cathode active material.

### Comparative Example 5

An aqueous metal salt solution having a Ni:Co:Mn molar ratio of 90:05:05 along with caustic soda and an aqueous ammonia solution was added to a 500 L cylindrical reactor, into which nitrogen gas was injected at a constant rate of 0.1 L/min, using a metering pump and synthesis was performed at 60° C. by coprecipitation. At this time, the pH was maintained at 11.3 to 11.7, the ammonia concentration was maintained at 4,000 to 5,000 ppm and stirring was performed at a constant rate of 360 rpm to obtain Ni—Co—Mn composite transition metal hydroxide particles having D50 of 10 μm.

LiOH was mixed with the composite transition metal hydroxide precursor prepared above at a molar ratio of 1.03, followed by heat-treating at 800° C. for 18 hours to prepare a cathode active material.

### Comparative Example 6

An aqueous metal salt solution having a Ni:Co:Mn molar ratio of 95:2.5:2.5 along with caustic soda and an aqueous ammonia solution was added to a 500 L cylindrical reactor, into which nitrogen gas was injected at a constant rate of 0.1 L/min, using a metering pump and synthesis was performed at 60° C. by coprecipitation. At this time, the pH was maintained at 11.3 to 11.7, the ammonia concentration was maintained at 4,000 to 5,000 ppm and stirring was performed at a constant rate of 360 rpm to obtain Ni—Co—Mn composite transition metal hydroxide particles having D50 of 10 μm.

LiOH was mixed with the composite transition metal hydroxide precursor prepared above at a molar ratio of 1.03, followed by heat-treating at 800° C. for 18 hours to prepare a cathode active material.

### Experimental Example 1

XRD analysis was performed on the composite transition metal hydroxide particles and cathode active material particles prepared in Examples 1 to 9 and Comparative Examples 1 to 6, under the following measurement conditions, and the results are shown in Tables 1 and 3.

### XRD Measurement Conditions

Power source: CuKα (line focus), Wavelength: 1.541836 Å
Operation axis: 2θ/θ, Measurement method: Continuous, Coefficient unit: cps
Start angle: 10.0°, End angle: 80.0°, Number of integrations: 1 time
Sampling width: 0.01°, scan speed: 1.3°/min
Voltage: 40 kV, current: 40 mA
Divergence slit: 0.2 mm, divergence limiting slit: 10 mm
Scatter slit: open, light-receiving slit: open
Offset angle: 0°
Goniometer radius: 285 mm, Optical System: Concentration
Attachment: ASC-48
Slit: Slit for D/teX Ultra
Detector: D/teX Ultra
Incident Monochrome: CBO
Ni-Kβ Filter: None
Rotational Speed: 30 rpm

TABLE 1

| | | Particle | | | | | | |
|---|---|---|---|---|---|---|---|---|
| | Active material | diameter | Precursor | | Active material | | | |
| | composition | D50(μm) | I_{(100/001)} | I_{(101/001)} | a | c | c/a | I_{(003/104)} |
| Example 1 | Li_{1.03} Ni_{0.8}Co_{0.1}Mn_{0.1} | 10 | 0.54 | 1 | 2.872 | 14.199 | 4.945 | 1.857 |
| Example 2 | Li_{1.03} Ni_{0.8}Co_{0.1}Mn_{0.1} | 10 | 0.72 | 1.08 | 2.872 | 14.2 | 4.945 | 1.846 |
| Example 3 | Li_{1.03} Ni_{0.8}Co_{0.1}Mn_{0.1} | 10 | 0.64 | 0.74 | 2.872 | 14.198 | 4.944 | 1.829 |
| Example 4 | Li_{1.03}Ni_{0.82}Co_{0.11}Mn_{0.07} | 10 | 0.43 | 0.89 | 2.871 | 14.186 | 4.944 | 1.812 |
| Comparative | Li_{1.03}Ni_{0.82}Co_{0.11}Mn_{0.07} | 10 | 0.28 | 0.64 | 2.872 | 14.193 | 4.943 | 1.507 |
| Example 1 | | | | | | | | |
| Example 5 | Li_{1.03} Ni_{0.8}Co_{0.1}Mn_{0.1} | 3 | 0.65 | 1.03 | 2.873 | 14.201 | 4.943 | 1.979 |
| Comparative | Li_{1.03}Ni_{0.82}Co_{0.11}Mn_{0.07} | 3 | 0.39 | 0.55 | 2.87 | 14.184 | 4.943 | 1.421 |
| Example 2 | | | | | | | | |
| Example 6 | Li_{1.03}Ni_{0.8}Co_{0.1}Mn_{0.1} | 16 | 0.7 | 1.01 | 2.874 | 14.202 | 4.942 | 2.046 |
| Comparative | Li_{1.03}Ni_{0.82}Co_{0.11}Mn_{0.07} | 16 | 0.28 | 0.53 | 2.87 | 14.181 | 4.941 | 1.551 |
| Example 3 | | | | | | | | |
| Example 7 | Li_{1.03}Ni_{0.7}Co_{0.15}Mn_{0.15} | 10 | 0.76 | 1.05 | 2.872 | 14.232 | 4.953 | 2.07 |
| Comparative | Li_{1.03} Ni_{0.7}Co_{0.15}Mn_{0.15} | 10 | 0.28 | 0.68 | 2.871 | 14.187 | 4.942 | 1.322 |
| Example 4 | | | | | | | | |
| Example 8 | Li_{1.03}Ni_{0.9}Co_{0.05}Mn_{0.05} | 10 | 0.58 | 0.98 | 2.873 | 14.203 | 4.944 | 2.043 |
| Comparative | Li_{1.03}Ni_{0.9}Co_{0.05}Mn_{0.05} | 10 | 0.38 | 0.57 | 2.87 | 14.183 | 4.923 | 1.405 |
| Example 5 | | | | | | | | |
| Example 9 | Li_{1.03}Ni_{0.95}Co_{0.025}Mn_{0.025} | 10 | 0.63 | 1 | 2.875 | 14.207 | 4.942 | 2.044 |
| Comparative | Li_{1.03} Ni_{0.95}Co_{0.025}Mn_{0.025} | 10 | 0.35 | 0.61 | 2.872 | 14.185 | 4.944 | 1.235 |
| Example 6 | | | | | | | | |

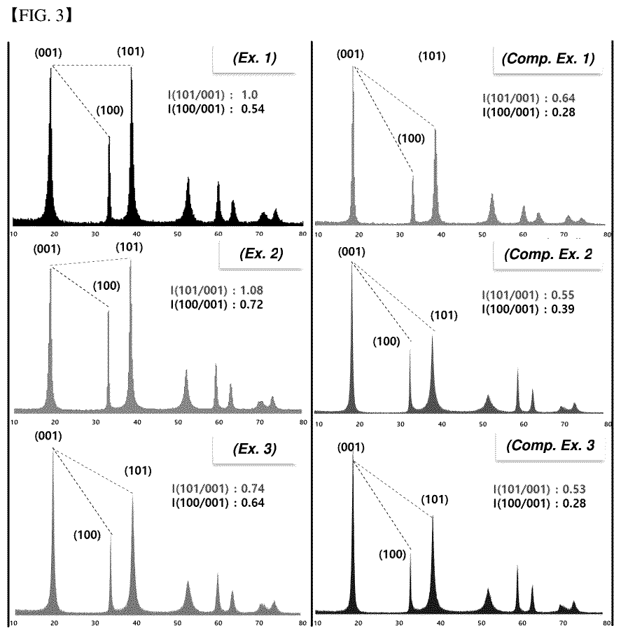

As can be seen from Table 1 as well as the results of FIG. 3, the precursors according to Examples of the present invention have a peak intensity ratio (I₁₀₀/I₀₀₁) of the (100) plane to the (001) plane in the range of 0.4 to 0.8, and an intensity ratio (I₁₀₁/I₀₀₁) of the (101) plane to the (001) plane in the range of 0.7 to 1.1, whereas the precursors of Comparative Examples have the intensity ratio and the peak intensity ratio not falling within the ranges defined above. In addition, as can be seen from Table 1, the cathode active materials formed of the precursors according to Examples of the present invention have an intensity ratio (003/104) of the (003) plane to the (104) plane in the range of 1.8 to 2.1, and c/a of 4.9 or more, whereas the cathode active materials of Comparative Examples have an intensity ratio (003/104) not more than 1.6.

### Experimental Example 2

The cathode active material prepared in each of Examples 1 to 9 and Comparative Examples 1 to 6, Super-P as a conductive material, and PVdF as a binder were mixed at a weight ratio of 96.5:1.5:2 in the presence of N-methylpyrrolidone as a solvent to prepare a cathode active material paste. The cathode active material paste was applied onto an aluminum current collector, dried at 120° C., and then rolled to produce a cathode.

A porous polyethylene film as a separator was interposed between the cathode produced above and Li metal as an anode to produce an electrode assembly, the electrode assembly was placed in a battery case, and an electrolyte was injected into the battery case to produce a lithium secondary battery. The electrolyte used herein was prepared by dissolving 1.0M lithium hexafluorophosphate (LiPF₆) in an organic solvent containing vinylene carbonate (VC: 2 wt %), in addition to ethylene carbonate/dimethyl carbonate/diethyl carbonate (mixed at a volume ratio of EC/DMC/DEC=1/2/1).

Each of the lithium secondary batteries thus produced was subjected to 0.1 C charge and 0.1 C discharge at room temperature wherein charging was performed at 4.3 V and the discharge cutoff voltage was 3.0 V. The discharge capacity at 30 cycles was compared with the discharge capacity at 1 cycle, and the result is shown in Table 2 below.

TABLE 2

| | | Charge | Discharge | | |
|---|---|---|---|---|---|
| | Active material | capacity | capacity | Lifespan | DCIR(Ω) |
| | composition | (mAh/g) | (mAh/g) | (30 cycles) | (30 cycles) |
| Example 1 | Li_{1.03}Ni_{0.8}Co_{0.1}Mn_{0.1} | 220.67 | 195.35 | 98.28 | 23.71 |
| Example 2 | Li_{1.03}Ni_{0.8}Co_{0.1}Mn_{0.1} | 221.43 | 196.58 | 98.92 | 25.46 |
| Example 3 | Li_{1.03}Ni_{0.8}Co_{0.1}Mn_{0.1} | 221.28 | 195.24 | 98.87 | 27.91 |
| Example 4 | Li_{1.03}Ni_{0.82}Co_{0.11}Mn_{0.07} | 221.52 | 195.68 | 98.1 | 25.06 |
| Comparative | Li_{1.03}Ni_{0.82}Co_{0.11}Mn_{0.07} | 224.1 | 192.51 | 95.79 | 52.64 |
| Example 1 | | | | | |
| Example 5 | Li_{1.03}Ni_{0.8}Co_{0.1}Mn_{0.1} | 223.51 | 205.12 | 94.07 | 12.59 |
| Comparative | Li_{1.03}Ni_{0.82}Co_{0.11}Mn_{0.07} | 225.23 | 193.12 | 90.04 | 61.98 |
| Example 2 | | | | | |
| Example 6 | Li_{1.03}Ni_{0.8}Co_{0.1}Mn_{0.1} | 240.8 | 216.1 | 93.9 | 23.22 |
| Comparative | Li_{1.03}Ni_{0.82}Co_{0.11}Mn_{0.07} | 226.78 | 193.25 | 92.9 | 81.98 |
| Example 3 | | | | | |
| Example 7 | Li_{1.03}Ni_{0.7}Co_{0.15}Mn_{0.15} | 212.6 | 195 | 96.7 | 14.81 |
| Comparative | Li_{1.03}Ni_{0.7}Co_{0.15}Mn_{0.15} | 220.03 | 195 | 93.1 | 54.13 |
| Example 4 | | | | | |
| Example 8 | Li_{1.03}Ni_{0.9}Co_{0.05}Mn_{0.05} | 241.63 | 213.58 | 93.38 | 25.1 |
| Comparative | Li_{1.03}Ni_{0.9}Co_{0.05}Mn_{0.05} | 252.48 | 213.58 | 90.01 | 78.72 |
| Example 5 | | | | | |
| Example 9 | Li_{1.03}Ni_{0.95}Co_{0.025}Mn_{0.025} | 242.19 | 214.36 | 91.01 | 24.52 |
| Comparative | Li_{1.03}Ni_{0.95}Co_{0.025}Mn_{0.025} | 251.87 | 214.36 | 87.26 | 63.61 |
| Example 6 | | | | | |

As can be seen from Table 2, the lithium secondary batteries according to Examples of the present invention generally have high discharge efficiency, excellent cycle characteristics, and reduced DCIR (direct current internal resistance) increase related to lifespan of secondary batteries, and thus excellent resistance.

Although preferred embodiments of the present invention have been disclosed for illustrative purposes, those skilled in the art will appreciate that various modifications, additions and substitutions are possible, without departing from the scope and spirit of the invention as disclosed in the accompanying claims.

1. A composite transition metal precursor for a cathode active material comprising Ni and at least one transition metal,
wherein a molar amount of Ni is 60% or more based on a total amount of transition metal and a ratio (I₁₀₁/I₀₀₁) of an intensity of a (101) plane to an intensity of a (001) plane ranges from 0.7 to 1.1 in an XRD analysis.

2. The composite transition metal precursor according to claim 1, wherein a ratio (I₁₀₀/I₀₀₁) of a peak intensity of a (100) plane to a peak intensity of the (001) plane ranges from 0.4 to 0.8 in the XRD analysis.

3. The composite transition metal precursor according to claim 1, wherein a peak observed at around 18° corresponds to the intensity of the (001) plane, a peak observed at around 33° corresponds to the intensity of the (100) plane, and a peak observed at around 38° corresponds to the intensity of the (101) plane.

4. The composite transition metal precursor according to claim 1, wherein the transition metal comprises Co and Mn.

5. The composite transition metal precursor according to claim 1, wherein the composite transition metal precursor comprises at least one selected from the group consisting of M(OH)₂, M(OOH), and M(OH₁₋ₓ)₂,
wherein M includes Ni and at least one transition metal; and
x satisfies the requirement of 0<x<0.5.

6. The composite transition metal precursor according to claim 1, wherein the composite transition metal precursor is represented by Formula 1 below:
Ni_{1-(a+b+c)}CoₐMn_{b}M_{c}(OH)₂ (1)
wherein
M includes at least one element selected from the group consisting of B, Al, Ti, Sc, V, Cr, Fe, Y, Cu, Zr, Nb, Mo, Tc, Ru, Rh, Ag, Pd, P, and W; and
the requirements of 0≤a<1, 0≤b<1, 0≤c<1 and 0<a+b+c≤0.3 are satisfied.

7. The composite transition metal precursor according to claim 1, wherein the ratio (I₁₀₁/I₀₀₁) of the intensity of the (101) plane to the intensity of the (001) plane ranges from 0.74 to 1.08.

8. The composite transition metal precursor according to claim 1, wherein the ratio (I₁₀₀/I₀₀₁) of the peak intensity of the (100) plane to the peak intensity of the (001) plane ranges from 0.43 to 0.76.

9. A cathode active material prepared by firing the cathode active material according to claim 1 along with a lithium source.

10. The cathode active material according to claim 9, wherein a ratio (003/104) of an intensity of a (003) plane to an intensity of a (104) plane at an XRD main peak is 1.8 or more.

11. The cathode active material according to claim 10, wherein the ratio (003/104) of the intensity of the (003) plane to the intensity of the (104) plane at the XRD main peak is 1.8 to 2.1.

12. The cathode active material according to claim 9, wherein c/a is 4.9 or more in the XRD analysis.

13. A lithium secondary battery comprising the cathode active material according to claim 9.
